(19) United States
(12) Patent Application Publication
(10) Pub. No.: US 2018/0276870 A1
(43) Pub. Date: Sep. 27, 2018

(54) SYSTEM AND METHOD FOR MASS-ANIMATING CHARACTERS IN ANIMATED SEQUENCES

(71) Applicant: MZ IP Holdings, LLC, Palo Alto, CA (US)

(72) Inventor: David Redkey, Belmont, CA (US)

(21) Appl. No.: 15/934,020

(22) Filed: Mar. 23, 2018

Related U.S. Application Data
(60) Provisional application No. 62/476,201, filed on Mar. 24, 2017.

(51) Int. Cl. G06T 13/40; G06T 15/04; G06T 17/20

(52) U.S. Cl. CPC G06T 13/40; G06T 2213/08; G06T 17/20; G06T 15/04

(57) ABSTRACT

Implementations of the present disclosure are directed to a method, a system, and an article for animating characters in a virtual environment. An example computer-implemented method can include: (a) generating a plurality of snapshots of a 3D mesh in an animation sequence, wherein each snapshot includes the 3D mesh in a distinct frame of the animation sequence, and wherein the animation sequence includes a loop; (b) assigning each frame of the animation sequence to one of a plurality of 3D virtual objects corresponding to the 3D mesh; (c) rendering a graphical image including the plurality of 3D virtual objects according to the assigned frames; (d) incrementing the assigned frame for each 3D virtual object to a next frame in the loop; and (e) repeating steps (c) and (d).

### CROSS-REFERENCE TO RELATED APPLICATIONS

This application claims the benefit of U.S. Provisional Patent Application No. 62/476,201, filed Mar. 24, 2017, the entire contents of which are incorporated by reference herein.

### BACKGROUND

The present disclosure relates to generating images of a virtual environment and, in certain examples, to systems and methods for animating a large number of virtual characters simultaneously.

In general, a primary concern in graphically rendering large numbers of virtual, animating characters at once, particularly on mobile devices, is a CPU drain associated with issuing a separate draw call for every character. Draw calls can be computationally expensive and can have a massive impact on low-end CPUs, especially on mobile platforms. It is generally difficult or impossible to issue a separate draw call for each of hundreds of characters at suitable frame rates (e.g., 30 frames per second) on such low-end devices. While high-end devices, such as modern personal computers, can reduce or avoid draw calls using texture and/or a vertex shader, such an approach is typically not available on low-end devices.

### SUMMARY

In general, the systems and methods described herein can be used to efficiently render a large number (e.g., 50, 100, 500, 1000, or more) of animating characters in a virtual environment. A plurality of snapshots of a 3D mesh can be created for an animation loop in which a character is performing a repetitive motion, such as walking or running. Each snapshot in the loop can represent the character in a different pose during the repetitive motion. To begin the animation, each snapshot can be assigned to a distinct character from a collection of virtual characters that are preferably similar in shape or appearance. A graphical image showing the characters in the different poses can then be rendered according to the assigned snapshots. After incrementing the assigned snapshot for each character to a next snapshot in the loop, a new graphical image, showing the characters in advanced poses, can be rendered. Repetitive motion can be achieved by repeatedly incrementing the snapshot assignment for each character and rendering a new graphical image, at a desired frame rate.

Advantageously, the approach described herein can achieve a significant reduction in draw calls (e.g., by a factor of 30 or more) without using vertex texturing or related techniques that may not be available on certain mobile devices (e.g., Open GL ES 2.0 ANDROID devices). Alternatively or additionally, the approach can eliminate a need for per-frame skinning (e.g., in the shader), which can require calculating vertex locations by adding up contributions of character bone weights and/or can include up to 4 matrix-vertex multiplications. The approach can achieve texture mapping, shadows, specular and diffuse lighting, and normal mapping on over 500 (or more) characters at once on low-end mobile devices (e.g., mobile devices sold before 2013) and/or low-end personal computers (e.g., personal computers sold before 2010). For example, the approach can be used to render 500 marching soldiers, of varying sizes and in different directions and colors, independently located on the screen of a low-end mobile device.

In one aspect, the subject matter described in this specification relates to a computer-implemented method. The method includes: (a) generating a plurality of snapshots of a 3D mesh in an animation sequence, each snapshot including the 3D mesh in a distinct frame of the animation sequence, the animation sequence including or defining a loop; (b) assigning each frame of the animation sequence to one of a plurality of 3D virtual objects corresponding to the 3D mesh; (c) rendering a graphical image including the plurality of 3D virtual objects according to the assigned frames; (d) incrementing the assigned frame for each 3D virtual object to a next frame in the loop; and (e) repeating steps (c) and (d).

In certain examples, the 3D virtual object can include a virtual animal and/or a virtual person. The loop can include a cycle of a repetitive movement. Step (a) can include performing a draw call. Alternatively or additionally, step (a) can include: providing a vertex buffer; and storing, in the vertex buffer, vertex locations for the 3D mesh for each frame in the loop. Step (b) can include assigning each frame to a distinct 3D virtual object from the plurality of 3D virtual objects.

In some implementations, a number of snapshots in the plurality of snapshots can be equal to a number of 3D virtual objects in the plurality of 3D virtual objects. Step (c) can include: determining a position and an orientation for each 3D virtual object; and drawing each 3D virtual object in the graphical image according to the position and the orientation. Step (c) can include applying at least one texture to the 3D mesh. Step (e) can include repeating steps (c) and (d) until each frame in the loop has been assigned to each 3D virtual object.

In another aspect, the subject matter described in this specification relates to a system. The system includes one or more computer processors programmed to perform operations including: (a) generating a plurality of snapshots of a 3D mesh in an animation sequence, each snapshot including the 3D mesh in a distinct frame of the animation sequence, the animation sequence including or defining a loop; (b) assigning each frame of the animation sequence to one of a plurality of 3D virtual objects corresponding to the 3D mesh; (c) rendering a graphical image including the plurality of 3D virtual objects according to the assigned frames; (d) incrementing the assigned frame for each 3D virtual object to a next frame in the loop; and (e) repeating steps (c) and (d).

In various examples, the 3D virtual object can include a virtual animal and/or a virtual person. The loop can include a cycle of a repetitive movement. Step (a) can include performing a draw call. Alternatively or additionally, step (a) can include: providing a vertex buffer; and storing, in the vertex buffer, vertex locations for the 3D mesh for each frame in the loop. Step (b) can include assigning each frame to a distinct 3D virtual object from the plurality of 3D virtual objects.

In certain instances, a number of snapshots in the plurality of snapshots can be equal to a number of 3D virtual objects in the plurality of 3D virtual objects. Step (c) can include: determining a position and an orientation for each 3D virtual object; and drawing each 3D virtual object in the graphical image according to the position and the orientation. Step (c) can include applying at least one texture to the 3D mesh. Step (e) can include repeating steps (c) and (d) until each frame in the loop has been assigned to each 3D virtual object.

In another aspect, the subject matter described in this specification relates to an article. The article includes a non-transitory computer-readable medium having instructions stored thereon that, when executed by one or more computer processors, cause the computer processors to perform operations including: (a) generating a plurality of snapshots of a 3D mesh in an animation sequence, each snapshot including the 3D mesh in a distinct frame of the animation sequence, the animation sequence including or defining a loop; (b) assigning each frame of the animation sequence to one of a plurality of 3D virtual objects corresponding to the 3D mesh; (c) rendering a graphical image including the plurality of 3D virtual objects according to the assigned frames; (d) incrementing the assigned frame for each 3D virtual object to a next frame in the loop; and (e) repeating steps (c) and (d).

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for mass-animating large numbers of characters in animated sequences.

FIGS. 2A-2F include images of a character in different poses for an animated sequence.

FIG. 3 is a flowchart of an example method of mass-animating large numbers of characters in animated sequences.

### DETAILED DESCRIPTION

In various implementations, the systems and methods described herein can be used to generate animations of virtual characters or other virtual objects (e.g., machines or robots) performing repetitive movements in a virtual environment. The repetitive movements can include, for example, walking, marching, running, flapping wings, swinging an object (e.g., a hammer or a sword), moving a limb, turning a head, or the like. The virtual characters can be or include, for example, virtual people, virtual animals, or other virtual creatures (e.g., monsters or mythical creatures). The animations can be or include a sequence of frames or images (e.g., a video) in which a large number of virtual characters (e.g., 30, 100, 500, or more) are performing a repetitive movement, such as walking. The virtual characters can each be rendered in a different location of the images and/or can be oriented or moving in different directions, as desired. Such animations of multiple characters can be referred to herein as “mass-animations.”

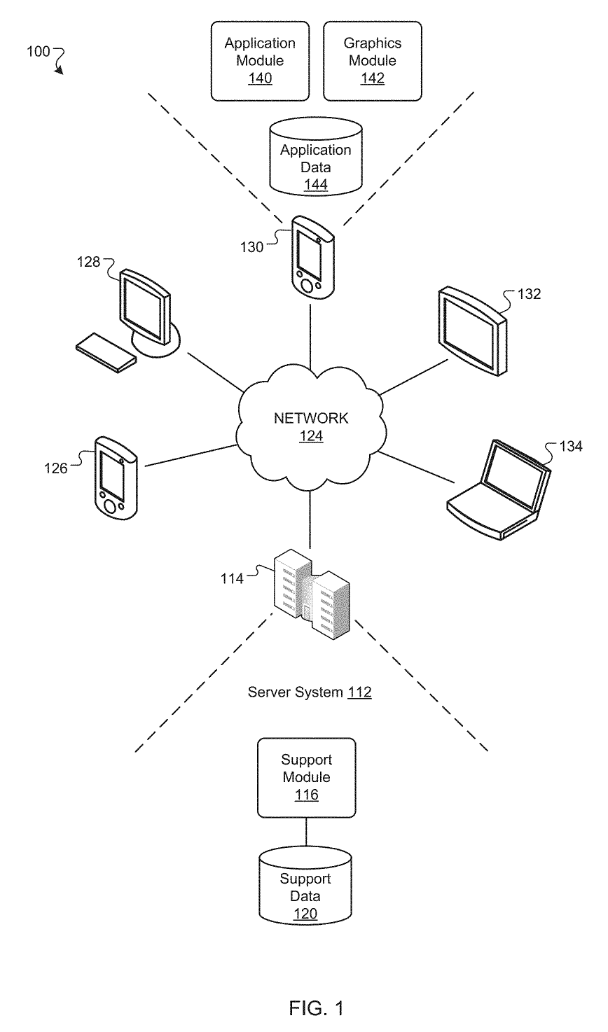

FIG. 1 illustrates an example system 100 for generating mass-animations of multiple characters in a virtual environment. A server system 112 provides functionality for a software application provided to a plurality of users. The server system 112 includes software components and databases that can be deployed at one or more data centers 114 in one or more geographic locations, for example. The server system 112 software components can include a support module 116 and/or can include subcomponents that can execute on the same or on different individual data processing apparatus. The server system 112 databases can include a support data 120 database. The databases can reside in one or more physical storage systems. The software components and data will be further described below.

An application, such as, for example, a web-based or other software application can be provided as an end-user application to allow users to interact with the server system 112. The software application can be accessed through a network 124 (e.g., the Internet) by users of client devices, such as a smart phone 126, a personal computer 128, a smart phone 130, a tablet computer 132, and a laptop computer 134. Other client devices are possible.

Each client device in the system 100 can utilize or include software components and databases for the software application. The software components on the client devices can include an application module 140 and a graphics module 142. The application module 140 can implement the software application on each client device. The graphics module 142 can be used to render graphics for a virtual environment associated with the software application. The databases on the client devices can include an application data 144 database, which can store data for the software application and exchange the data with the application module 140 and/or the graphics module 142. The data stored on the application data 144 database can include, for example, mesh data, image data, video data, user data, and any other data used or generated by the application module 140 and/or the graphics module 142. While the application module 140, the graphics module 142, and the application data 144 database are depicted as being associated with the smart phone 130, it is understood that other client devices (e.g., the smart phone 126, the personal computer 128, the tablet computer 132, and/or the laptop computer 134) can include the application module 140, the graphics module 142, the application data 144 database, and any portions thereof.

Still referring to FIG. 1, the support module 116 can include software components that support the software application by, for example, performing calculations, implementing software updates, exchanging information or data with the application module 140 and/or the graphics module 142, and/or monitoring an overall status of the software application. The support data 120 database can store and provide data for the software application. The data can include, for example, user data, image data, video data, and/or any other data that can be used by the server system 112 and/or client devices to run the software application. In certain instances, for example, the support module 116 can retrieve image data or user data from the support data 120 database and send the image data or the user data to client devices, using the network 124.

The software application implemented on the client devices 126, 128, 130, 132, and 134 can relate to and/or provide a wide variety of functions and information, including, for example, entertainment (e.g., a game, music, videos, etc.), science, engineering (e.g., mathematical modeling), business, news, weather, finance, sports, etc. In preferred implementations, the software application can provide and display a virtual environment for a game, such as a multi-player online game.

In various examples, the systems and methods described herein can generate mass-animations by creating, up front, a sequence of three-dimensional (3D) snapshots of a character in different poses throughout a repetitive movement. For example, when the repetitive movement is walking, the snapshots can include multiple images (e.g., 10, 30, or 60) of the character in different stages of walking (e.g., two full steps for a human character). The virtual character in each snapshot can be generated using (or can be represented by) a collection of mesh elements, which can be triangular and can include vertices. The mesh elements can define an outer surface of the virtual character. Texture and/or skinning can be applied to the mesh to add detail and/or give the character a more realistic appearance. The sequence of 3D snapshots can be referred to herein as a “3D flipbook.”

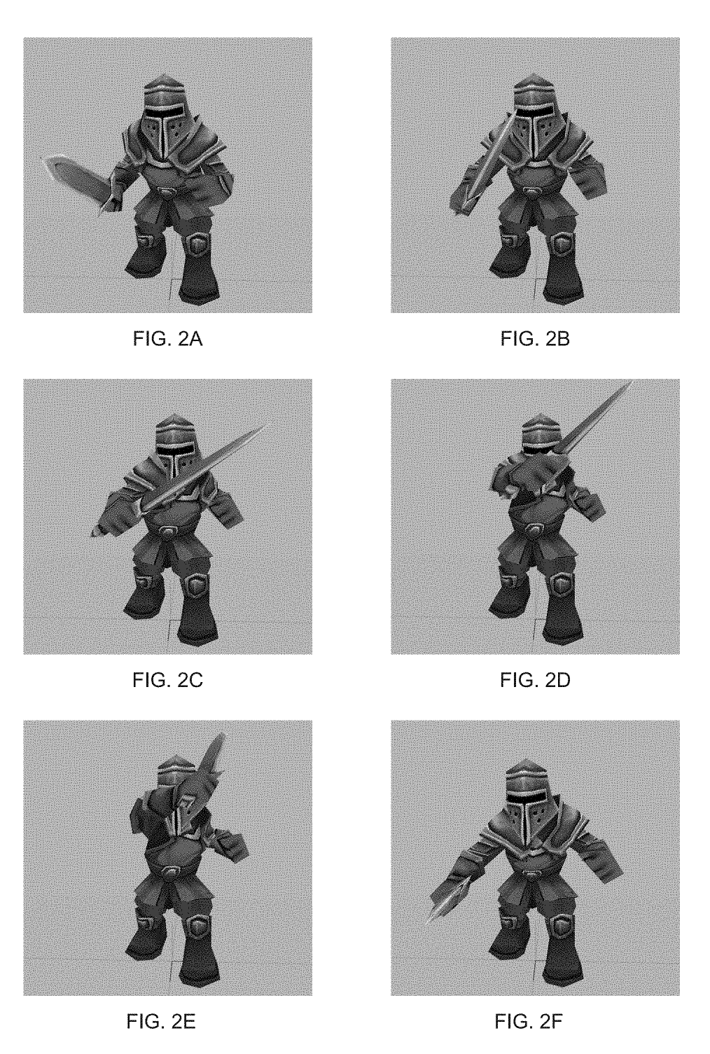

For example, FIGS. 2A-2F include six images generated from 3D flipbook snapshots of a virtual character (e.g., a virtual knight) swinging a sword. It is understood that the 3D flipbook can include snapshots for more than the six images presented in these figures. The 3D flipbook can include, for example, 6, 10, 15, 30, 60, or more snapshots, as desired. A preferred number of snapshots for the 3D flipbook is 30.

In general, the snapshots in the 3D flipbook can be or include mesh information stored in one or more buffers (e.g., a vertex buffer and/or an index buffer), as described herein. The mesh information can include, for example, mesh vertex positions, texture information, and/or skinning information. The mesh information may or may not include images or image data.

To generate a sequence of images with one animating character, the system 100 (e.g., using the graphics module 142) can increment or flip through the snapshots of the 3D flipbook. For example, a first image in the sequence can be generated using a first snapshot from the 3D flipbook. Successive images can be generated by incrementing or flipping through an index of the 3D flipbook snapshots, to create an illusion of motion. The index can be incremented, for example, according to an elapsed time between images. Upon reaching the last snapshot in the 3D flipbook, the character can be looped around again to the first snapshot. The motion shown in the 3D flipbook snapshots can be repeated over and over again, as desired, by looping through the 3D flipbook repeatedly. A frame rate for the animation can be, for example, 30 frames per second (FPS), though other frame rates (e.g., 15 FPS or 60 FPS) can be used.

To add additional animating characters to the sequence of images, the system 100 can assign each snapshot index in the 3D flipbook to a different character and cycle each character through the 3D flipbook at the same rate. As a result, there can be dozens (e.g., 30 for a one second animation with 30 flipbook snapshots, 60 for a two second animation with 60 flipbook snapshots, and so forth) of characters that can all be drawn at once using one copy of the 3D flipbook. Advantageously, because the 3D flipbook can be stored inside a single vertex buffer/index buffer pair, the system 100 can render all of the characters in a single draw call.

Table 1 presents an example in which 10 characters (A through J) are assigned to 10 snapshots (1 through 10) of a 3D flipbook. For a first image (i=1) in a sequence of images, characters A, B, C, . . . , I, and J are assigned to snapshot indices 1, 2, 3, . . . , 9, and 10, respectively. For the second image (i=2), each index assignment has been incremented by one, such that characters A, B, C, . . . , I, and J are assigned to snapshot indices 2, 3, 4, . . . , 10, and 1, respectively. In general, the snapshot index assignment for each character can be incremented by one with each successive image. When a character reaches the last index (10 in this example), the snapshot index can be moved back to index 1 for the next image. As the table indicates, the index assignments for the eleventh image (i=11) in this example are identical to the index assignments for the first image (i=1).

TABLE 1
Character index assignments for 3D flipbook.

| Index | i = 1 | i = 2 | i = 3 | . . . | i = 10 | i = 11 | i = 12 | . . . |
|---|---|---|---|---|---|---|---|---|
| 1 | A | J | I | . . . | B | A | J | . . . |
| 2 | B | A | J | . . . | C | B | A | . . . |
| 3 | C | B | A | . . . | D | C | B | . . . |
| 4 | D | C | B | . . . | E | D | C | . . . |
| 5 | E | D | C | . . . | F | E | D | . . . |
| 6 | F | E | D | . . . | G | F | E | . . . |
| 7 | G | F | E | . . . | H | G | F | . . . |
| 8 | H | G | F | . . . | I | H | G | . . . |
| 9 | I | H | G | . . . | J | I | H | . . . |
| 10 | J | I | H | . . . | A | J | I | . . . |

In a typical example, a number of characters in an animation can be greater than a number of snapshots in the 3D flipbook. For example, a 3D flipbook can include 30 snapshots yet the animation can include hundreds of characters. To animate more than 30 characters in such a case, the system 100 can reuse the 3D flipbook for each additional set of 30 characters. This can involve making one draw call for each batch of 30 characters, for example, which can result in a 30-to-1 reduction in draw calls. Individual instance information, such as, for example, position, orientation, scale, and color, can be sent as an array in the constant data for a draw call. Even on low-end mobile hardware, 128 Vector 4 registers can be sufficient to store instance information for more than 30 characters.

In various examples, the system 100 (e.g., using the graphics module 142) can configure a vertex buffer and an index buffer to store information (e.g., mesh vertex locations) for the 3D flipbook. The initial configuration can be performed on a client device and/or in an offline step to save network bandwidth.

For example, when a 3D flipbook includes K snapshots and a corresponding mesh includes N vertices, the graphics module 142 can generate the 3D flipbook snapshots by pre-transforming and/or concatenating the N vertices into a vertex buffer of size K×N. In preferred instances, K×N can be less than, for example, 64,000 so that 16-bit indices can be used in the index buffer. The vertex buffer is preferably configured to include room for an instance value, which can be used by a vertex shader to look up instance data, for example, for a snapshot to which a vertex belongs. The instance value can be the same for all vertices in a single snapshot. Additionally or alternatively, all data channels can be compressed down to a desired bit length, such as, for example, 8-bits, which can be sufficient for mass animation scenes, even on low-end mobile devices. Other bit-lengths are possible.

Table 2 lists exemplary parameters for data channels. In certain examples, a mesh scale global value can be used to scale positions back from a uniform 0-255 cube. Different vertex formats are possible; however, the parameters in Table 2 can be suitable for normal mapping, shadows, lighting, and texturing on low-end mobile devices.

TABLE 2
Example data channel parameters.

| Data Channel Parameter | Value |
|---|---|
| Position | 3 x, y, z values, scaled down to 0 to 255 |
| Normal | 3 x, y, z values |
| Tangent | 3 x, y, z values |
| UV | 2 u, v values |
| Instance ID | 1 integer value |

The index buffer can be configured to include K copies of a source index buffer. Each copy can be offset by a number of vertices in a source mesh. In some examples, the source mesh can be or include an original description of geometry for a character (e.g., un-posed) or other virtual object. The source mesh can be or include, for example, a collection of vertices and associated properties (e.g., vertex positions, texture coordinates, animation weights, etc.) and topological information for connecting the vertices into triangles, with each triangle having three vertex indices. Such topological information can be (or can be stored in) the index buffer. In general, the index buffer can include a copy of a triangle list for each snapshot in the 3D flipbook.

In various examples, a frame in an animation sequence can be rendered by determining a minimum number B of 3D flipbooks required to render the visible characters in the frame. This minimum number B can represent a number of batches or draw calls that will be used for the frame.

Each visible character can be categorized as being either newly visible or still visible, according to whether the character was visible in a previous frame. Characters that were in the previous frame and are still visible can require greater attention, because such characters should appear to be animating smoothly and should therefore receive an appropriate slot in the 3D flipbook, as defined by the vertex buffer. A smooth animation of these characters can be obtained by incrementing the snapshot indices appropriately around the 3D flipbook (e.g., based on elapsed time). If a given character's desired next index value is d, the available B batches of 3D flipbooks can be searched to determine if index d is available. If the index d is available in one of the 3D flipbooks, that index can be claimed for the character. Otherwise, the character can be dumped into the newly visible category and a different index (preferably close to index d) can be chosen for the character, which may have one frame of imperfect animation continuity.

For characters that are newly visible, an open index or slot can be chosen in one of the B batches of 3D flipbooks. The chosen index can be any available index. In some examples, the chosen index is preferably close to the first index.

Next, for each character in each batch of B batches, per-instance data (e.g., position, orientation, etc.) can be copied into a slot in a uniform array that corresponds to the batch and slot. The uniform array can include non-pose character-specific information, such as position, orientation, color, and similar information. For an animation having a number of frames F, for example, a character in batch b at slot s can be inserted at array index=b×F+s. In a given rendering frame, there can be any number of batches required to draw all the characters. For example, when there are 200 characters in an animation of 30 frames (e.g., 30 characters per batch), there can be 200±30=7 (rounded up to the nearest integer) batches. Whichever individual batch a chosen individual character belongs to can be indicated as batch b, which can be a number between 0 and 6, for example, when there are 7 batches. Additionally or alternatively, orientation can be provided as a two-dimensional unit vector, given that there is typically no need for tilt in such mass animations. For example, while characters can be oriented to face any compass direction in the virtual environment, the characters will typically not be tilted (e.g., sideways, backwards, or forwards with respect to ground). With no tilt, character orientation can be defined using only compass direction, which can result in data savings.

For any unused slots in the B batches of 3D flipbooks, data can be injected (e.g., into the uniform array) that causes a corresponding character instance to be invisible. This can be accomplished, for example, by setting both components of the 2D orientation vector to zero, which can cause all vertices to shrink to an origin. Alternatively or additionally, position can be set to zero, which can move all vertices off screen.

Next, a sequence of uniform values (e.g., mesh or character positions, orientations, and the like) can be transmitted to a shader, one batch at a time. A size of the batch can be equal to the number of frames F. The shader can render the uniform values for the desired mass-animation.

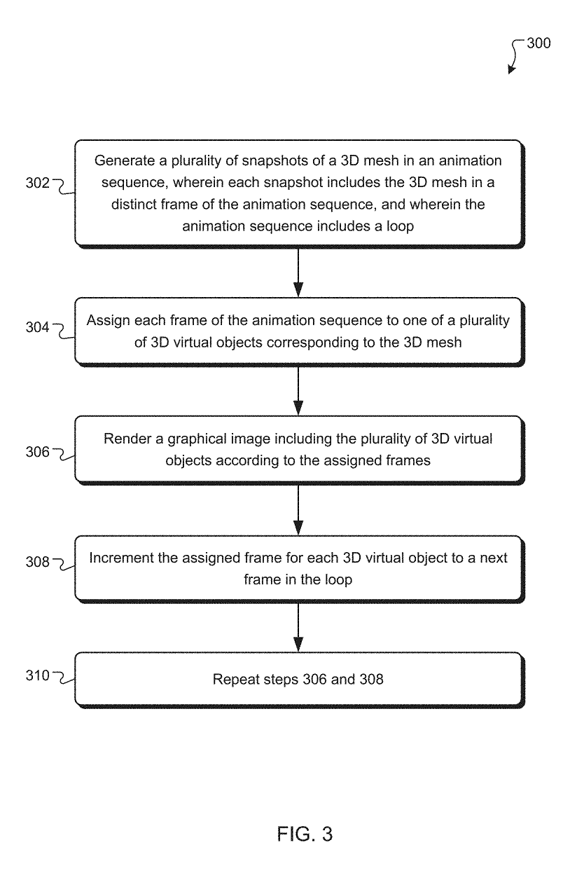

FIG. 3 illustrates an example computer-implemented method 300 of mass-animating multiple characters in animated sequences. A plurality of snapshots are generated (step 302) of a 3D mesh in an animation sequence (e.g., to form a 3D flipbook), in which each snapshot includes the 3D mesh (e.g., with or without texture and/or skinning applied) in a distinct frame of the animation sequence, and the plurality of snapshots includes a loop. Each frame of the animation sequence is assigned (step 304) to one of a plurality of 3D virtual objects corresponding to the 3D mesh. A graphical image is rendered (step 306) that includes the plurality of 3D virtual objects according to the assigned frames. The assigned frame for each 3D virtual object is incremented (step 308) to a next frame in the loop. Steps 306 and 308 are repeated (step 310).

In general, the systems and methods described herein can be ideally suited to cases in which a single animated mesh (e.g., performing a repetitive movement) is rendered for a large number of characters. The characters in the resulting sequence of animated images can be shown at different screen positions and/or orientations and are generally not synchronized with one another (e.g., due to characters being assigned to different snapshots in the 3D flipbook). In some examples, the characters can be customized in various ways, such as, for example, coloration (e.g., clothing, hair, or skin colors) and/or scale (e.g., tall or short). The character or mesh animations are preferably looping and/or show a repetitive movement, for example, by returning to a starting frame after a final frame has been reached. Additionally or alternatively, all characters in the animated sequence can be incremented at an identical rate through the animation loop. The character meshes can be on the order of about 500, 1000, or 2000 vertices in size, though other numbers of vertices can be used.

While the systems and methods described herein can be used on low-end devices (e.g., mobile devices), the approach is not limited to any particular kind of device platform and can be used with any suitable type of mobile, desktop, or laptop-style computer system. Older computer systems, for which the issue of CPU drain may be of concern, can benefit from the large reduction in draw calls achieved by the systems and methods described herein.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method, comprising:
(a) generating a plurality of snapshots of a 3D mesh in an animation sequence, each snapshot comprising the 3D mesh in a distinct frame of the animation sequence, the animation sequence comprising a loop;
(b) assigning each frame of the animation sequence to one of a plurality of 3D virtual objects corresponding to the 3D mesh;
(c) rendering a graphical image comprising the plurality of 3D virtual objects according to the assigned frames;
(d) incrementing the assigned frame for each 3D virtual object to a next frame in the loop; and
(e) repeating steps (c) and (d).

2. The method of claim 1, wherein the 3D virtual object comprises at least one of a virtual animal and a virtual person.

3. The method of claim 1, wherein the loop comprises a cycle of a repetitive movement.

4. The method of claim 1, wherein step (a) comprises:
performing a draw call.

5. The method of claim 1, wherein step (a) comprises:
providing a vertex buffer; and
storing, in the vertex buffer, vertex locations for the 3D mesh for each frame in the loop.

6. The method of claim 1, wherein step (b) comprises:
assigning each frame to a distinct 3D virtual object from the plurality of 3D virtual objects.

7. The method of claim 1, wherein a number of snapshots in the plurality of snapshots is equal to a number of 3D virtual objects in the plurality of 3D virtual objects.

8. The method of claim 1, wherein step (c) comprises:
determining a position and an orientation for each 3D virtual object; and
drawing each 3D virtual object in the graphical image according to the position and the orientation.

9. The method of claim 1, wherein step (c) comprises:
applying at least one texture to the 3D mesh.

10. The method of claim 1, wherein step (e) comprises:
repeating steps (c) and (d) until each frame in the loop has been assigned to each 3D virtual object.

11. A system, comprising:
one or more computer processors programmed to perform operations comprising:
(a) generating a plurality of snapshots of a 3D mesh in an animation sequence, each snapshot comprising the 3D mesh in a distinct frame of the animation sequence, the animation sequence comprising a loop;
(b) assigning each frame of the animation sequence to one of a plurality of 3D virtual objects corresponding to the 3D mesh;
(c) rendering a graphical image comprising the plurality of 3D virtual objects according to the assigned frames;
(d) incrementing the assigned frame for each 3D virtual object to a next frame in the loop; and
(e) repeating steps (c) and (d).

12. The system of claim 11, wherein the loop comprises a cycle of a repetitive movement.

13. The system of claim 11, wherein step (a) comprises:
performing a draw call.

14. The system of claim 11, wherein step (a) comprises:
providing a vertex buffer; and
storing, in the vertex buffer, vertex locations for the 3D mesh for each frame in the loop.

15. The system of claim 11, wherein step (b) comprises:
assigning each frame to a distinct 3D virtual object from the plurality of 3D virtual objects.

16. The system of claim 11, wherein a number of snapshots in the plurality of snapshots is equal to a number of 3D virtual objects in the plurality of 3D virtual objects.

17. The system of claim 11, wherein step (c) comprises:
determining a position and an orientation for each 3D virtual object; and
drawing each 3D virtual object in the graphical image according to the position and the orientation.

18. The system of claim 11, wherein step (c) comprises:
applying at least one texture to the 3D mesh.

19. The system of claim 11, wherein step (e) comprises:
repeating steps (c) and (d) until each frame in the loop has been assigned to each 3D virtual object.

20. An article, comprising:
a non-transitory computer-readable medium having instructions stored thereon that, when executed by one or more computer processors, cause the computer processors to perform operations comprising:
(a) generating a plurality of snapshots of a 3D mesh in an animation sequence, each snapshot comprising the 3D mesh in a distinct frame of the animation sequence, the animation sequence comprising a loop;
(b) assigning each frame of the animation sequence to one of a plurality of 3D virtual objects corresponding to the 3D mesh;
(c) rendering a graphical image comprising the plurality of 3D virtual objects according to the assigned frames;
(d) incrementing the assigned frame for each 3D virtual object to a next frame in the loop; and
(e) repeating steps (c) and (d).
